(19) United States
(12) Patent Application Publication
(10) Pub. No.: US 2025/0106290 A1
(43) Pub. Date: Mar. 27, 2025

(54) SYSTEMS AND METHODS FOR SUPPORTING TEMPORARY DATA BOOST

(71) Applicant: Meta Platforms Technologies, LLC, Menlo Park, CA (US)

(72) Inventors: Curt Wong, Bellevue, WA (US); Yousef Abdelmalek, New Providence, NJ (US); Liwen Yu, Santa Clara, CA (US); Xiaodi Zhang, San Ramon, CA (US)

(73) Assignee: Meta Platforms Technologies, LLC, Menlo Park, CA (US)

(21) Appl. No.: 18/626,772

(22) Filed: Apr. 4, 2024

Related U.S. Application Data
(60) Provisional application No. 63/539,659, filed on Sep. 21, 2023.

(51) Int. Cl. H04L 67/131; H04W 28/06

(52) U.S. Cl. CPC H04L 67/131; H04W 28/06

(57) ABSTRACT

Systems and methods for supporting a temporary data boost include a first wireless communication device which receives a signal from a second wireless communication device. The signal can include information for obtaining a model from a server used by the first wireless communication device to generate an avatar associated with a user of the second wireless communication device. The first wireless communication device can transmit a request to retrieve the model from the server, where the request identifies a data size of the model and an address of the server. The first wireless communication device may receive, via the core network from the server, data corresponding to the model from the server, where the data is prioritized by the core network according to the request.

### CROSS-REFERENCE TO RELATED APPLICATIONS

This application claims the benefit of and priority to U.S. Provisional Application No. 63/539,659, filed Sep. 21, 2023, the contents of which are incorporated herein by reference in their entirety.

### FIELD OF DISCLOSURE

The present disclosure is generally related to wireless communication between devices, including but not limited to, systems and methods for supporting temporary data boost.

### BACKGROUND

Augmented reality (AR), virtual reality (VR), and mixed reality (MR) are becoming more prevalent, which such technology being supported across a wider variety of platforms and device. Some AR/VR/MR devices may communicate with other devices within an environment via various cellular connections or links.

### SUMMARY

In one aspect, this disclosure is directed to a method. The method may include receiving, by a first wireless communication device, a signal from a second wireless communication device. The signal may include information (e.g., address and data size) for obtaining a model (e.g., UPM) from a server used by the first wireless communication device to generate an avatar associated with a user of the second wireless communication device. The method may include transmitting, by the first wireless communication device to a core network (e.g., to SMF), a request to retrieve the model from the server, the request identifying a data size of the model and an address of the server. The method may include receiving, by the first wireless communication device via the core network (e.g., via UPF) from the server, data corresponding to the model from the server, the data prioritized (e.g., prioritizes packets with temporary data boost indicator) by the core network according to the request.

In some embodiments, the signal includes the address of the server and the data size of the model. In some embodiments, the first wireless communication device receives the signal from the second wireless communication device (e.g., receives address and data size as part of session negotiation), to establish a communication session between the first wireless communication device and the second wireless communication device. In some embodiments, the method includes receiving, by the first wireless communication device, an identity code corresponding to the user of the second wireless communication device. In some embodiments, the identity code is received in the signal from the second wireless communication device. In some embodiments, a session management function (SMF) of the core network instructs a user plane function (UPF) of the core network to prioritize the data corresponding to the model from the server, by applying a downlink data burst indicator to data received from the server. In some embodiments, the downlink data burst indicator is applied to an amount of data received from the server equal to the data size of the model (e.g., may only prioritize data from the server up to data size for temporary data boost).

In some embodiments, the method includes configuring, by the first wireless communication device, the model received from the server using an identity code received from the second wireless communication device, to generate the avatar associated with the user of the second wireless communication device. In some embodiments, the method includes receiving, by the first wireless communication device, an expression code and an audio stream from the second wireless communication device. The method may include rendering, by the first wireless communication device, the avatar of the user according to the expression code. The method may include rendering, by the first wireless communication device, the audio stream synchronized with the rendering of the avatar.

In another aspect, this disclosure is directed to a first wireless communication device including a wireless transceiver and one or more processors configured to receive, via the wireless transceiver, a signal from a second wireless communication device. The signal may include information for obtaining a model from a server used by the first wireless communication device to generate an avatar associated with a user of the second wireless communication device. The one or more processors may be configured to transmit, via the wireless transceiver to a core network, a request to retrieve the model from the server, the request identifying a data size of the model and an address of the server. The one or more processors may be configured to receive, via the wireless transceiver, through the core network from the server, data corresponding to the model from the server, the data prioritized by the core network according to the request.

In some embodiments, the signal includes the address of the server and the data size of the model. In some embodiments, the one or more processors receive the signal from the second wireless communication device, to establish a communication session between the first wireless communication device and the second wireless communication device. In some embodiments, the one or more processors are configured to receive, via the wireless transceiver, an identity code corresponding to the user of the second wireless communication device. In some embodiments, the identity code is received in the signal from the second wireless communication device. In some embodiments, a session management function (SMF) of the core network instructs a user plane function (UPF) of the core network to prioritize the data corresponding to the model from the server, by applying a downlink data burst indicator to data received from the server. In some embodiments, the downlink data burst indicator is applied to an amount of data received from the server equal to the data size of the model.

In some embodiments, the one or more processors are configured to configure the model received from the server using an identity code received from the second wireless communication device, to generate the avatar associated with the user of the second wireless communication device. In some embodiments, the one or more processors are configured to receive, via the wireless transceiver, an expression code and an audio stream from the second wireless communication device. The one or more processors may be configured to render the avatar of the user according to the expression code, and can render the audio stream synchronized with the rendering of the avatar.

In yet another aspect, this disclosure is directed to a network node including one or more processors configured to implement a session management function (SMF) and implement a user plane function (UPF). The SMF may be configured to receive, from a wireless communication device, a request to retrieve data from a server, the request identifying a data size of the data to be retrieved from the server. The SMF may be configured to transmit, to the UPF, instructions to prioritize the data received from the server for transmission to the wireless communication device up to the data size. The UPF may be configured to apply, according to the instructions, a downlink burst indicator to the data received from the server, up to the data size. The UPF may be configured to transmit the data received from the server, with the downlink burst indicator, to a wireless communication node for transmission to the wireless communication device.

In some embodiments, the wireless communication node prioritizes transmission of the data including the downlink burst indicator to the wireless communication device, over other data for transmission to the wireless communication device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for supporting temporary data boost, according to an example implementation of the present disclosure.

FIG. 6 is another block diagram of a system for supporting temporary data boost, according to an example implementation of the present disclosure.

FIG. 7 is a diagram showing a process flow of supporting temporary data boost, according to an example implementation of the present disclosure.

FIG. 8 is a flowchart showing an example method for supporting temporary data boost, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

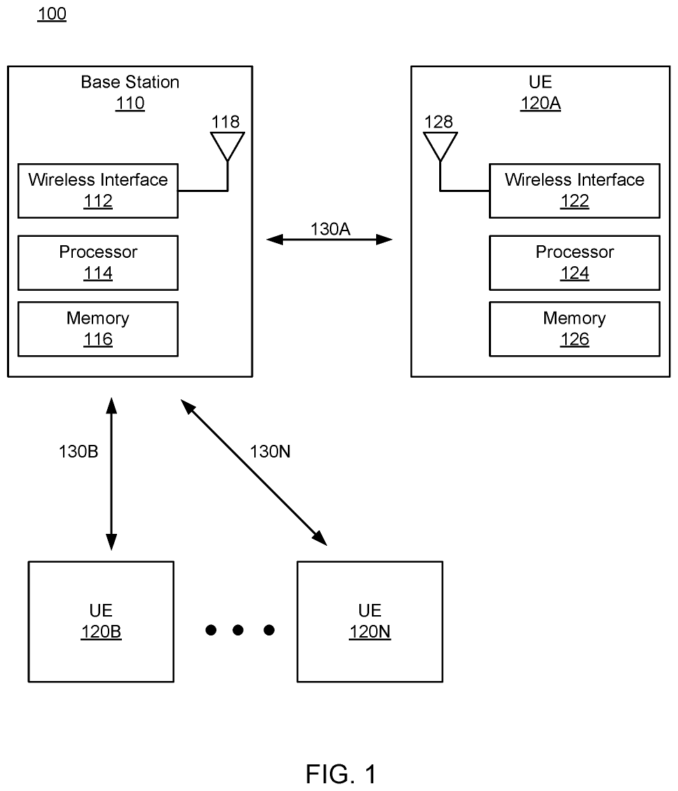

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

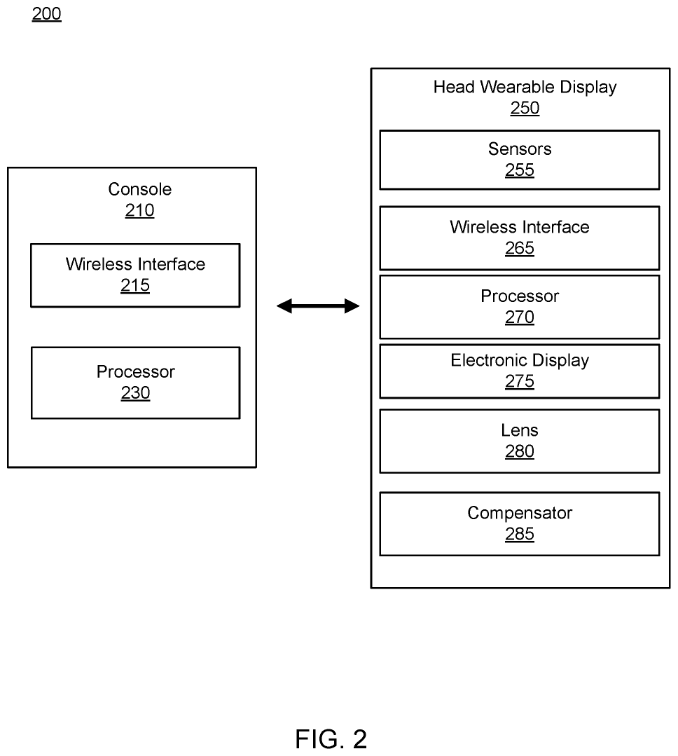

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

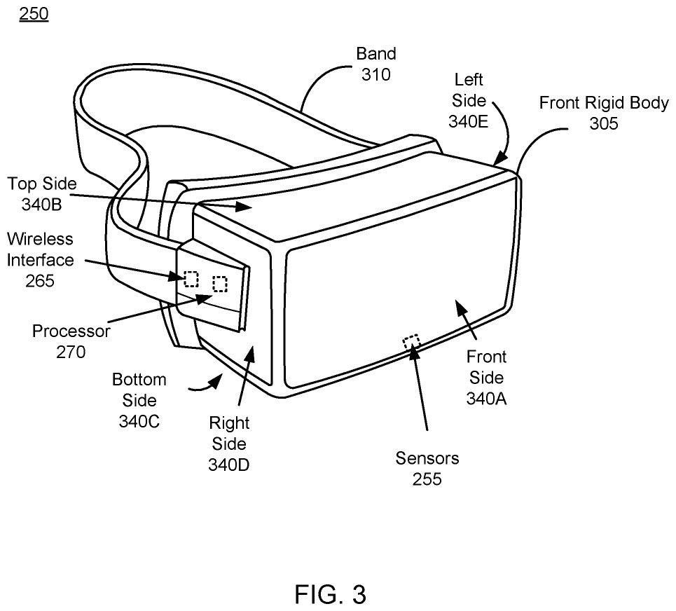

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

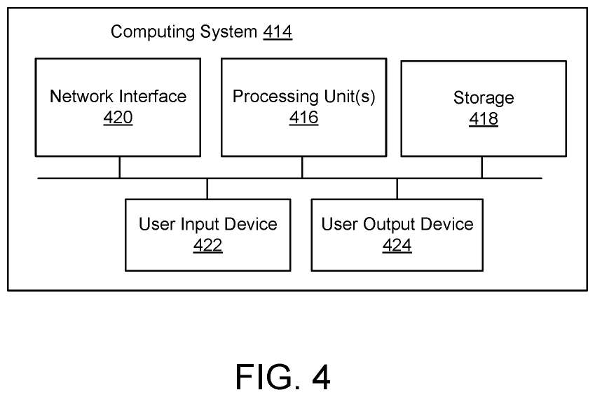

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

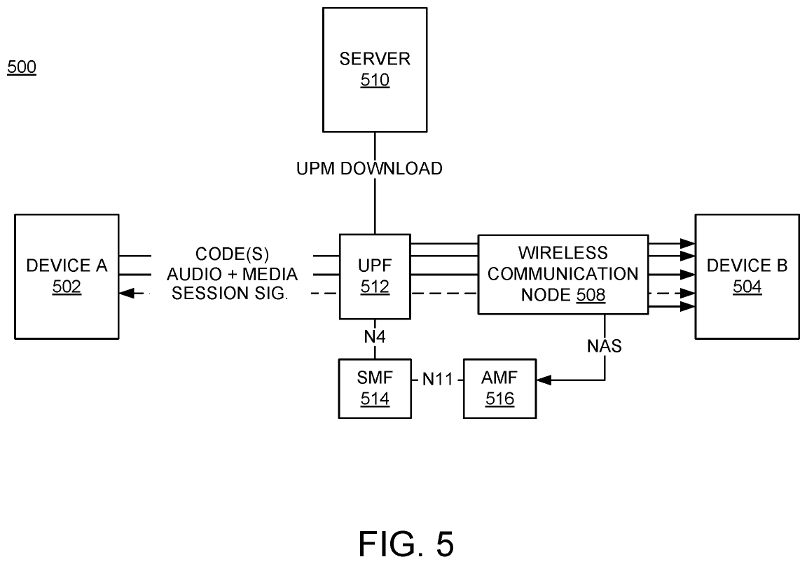

Referring generally to FIG. 5-FIG. 8, disclosed herein are systems and methods for managing avatar-based communications. In real-time communication sessions between devices, such as video and audio calls or conferences, both the audio and video streams may be sent from a sender (or sending device) to a receiver (or receiving device). Such communication sessions may have different quality of service (QoS) flows for the different streams. For example, the video stream could be sent at a first data rate (e.g., ˜1 Mb/s) while the audio stream could be sent at a second data rate (e.g., ˜200 Kb/s). In an avatar-based communication session, a video representation of the sender may be rendered based on an identity and expression code of the sender. Rendering of a representation/image of the sender may be based on a method using a universal prior model. This can produce a realistic real-time video of the sender.

Avatar-based communication can reduce uplink transmission bandwidth requirements on the sender side. To reduce the downlink bandwidth on the receiver side, the universal prior model may be downloaded to the receiver device for rendering the sender's avatar locally, based on the sender's identity and expression codes. Downloading the universal prior model may introduce extra session setup delay. Following cellular QoS handling, the UE may request/trigger the network to establish another higher priority QoS flow to download the UPM data file. However, this procedure may not be designed for short term usage, as it may induce QoS related signaling (such as a new QoS profile to RAN, SDF template to UPF, and QoS Rules to UE). For short term data boost related to avatar communication setup, a less complicated/intensive type of solution may be used to minimize the overall system load and setup time.

According to the systems and methods described herein, during avatar session setup, a sender device may include (e.g., in a packet or transmission) its identity code, the UPM server address, and UPM size, for sending to a receiver device. The receiver device, based on the UPM size, may request the network to establish a short term downlink data boost. For example, the receiver device may indicate the SMF (e.g., via AMF/Nll) the UPM server address and data size of the download. The SMF may update the service data flow (SDF) template to the UPF via N4. According to the updated SDF template, the UPF may prioritize DL traffic from the UPM server address until the download size limit is reached (e.., normal rate shaping may be disabled until the limit is reached) and may mark the specific traffic related to the UPM with an indicator in the GTP-header (N3). For example, the PDU from the UPM server may be marked with 5Q1-8+ a downlink burst indicator, while other traffic may only indicate 5Q1-8. If congestion handling is needed, the RAN may first perform rate shaping on PDUs which do not include the downlink burst indicator. In other words, the RAN can prioritize its scheduling for those PDUs which include the downlink burst indicator.

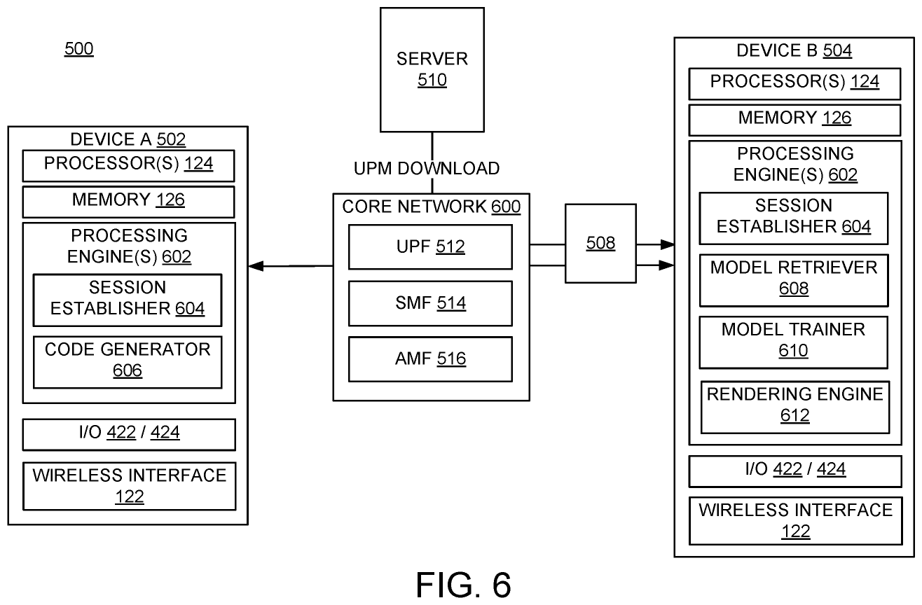

Referring to FIG. 5 and FIG. 6, depicted are block diagrams of a system 500 for supporting temporary data boost, according to example implementations of the present disclosure. As shown, the system 500 may include a first device 502 (also referred to as “device A 502”) and a second device 504 (also referred to as “device B 504”). The first device 502 and second device 504 may be similar to the UEs 120 described above with reference to FIG. 1-FIG. 4. As described in greater detail below, the first device 502 and second device 504 may be configured to establish a communication session with one another over the core network 600 via one or more wireless communication nodes 508. The second device 504 may receive a signal from the first device 502, which includes information for obtaining a model from the server 510 (e.g., the UPM described above), which can be used for generating an avatar associated with a user of the first device 502. The second device 504 may be configured to transmit a request to retrieve the model from the server 510 to the core network 600, and can receive data corresponding to the model from the server 510 via the core network. The data may be prioritized by the core network 600 according to the request from the second device 504.

Referring specifically to FIG. 6, the first device 502 and second device 504 may include processors 124, memory 126, and a wireless interface 124, which may be similar to the hardware described above with reference to FIG. 1-FIG. 4. The first device 502 and second device 504 may include a user input device 422 and user output device 424 (generally referred to as I/O), which may be similar to the user input device 422 and user output device 424 described above with reference to FIG. 4. The first device 502 and second device 504 may include one or more processing engines 602. The processing engine(s) 602 may be or include any device, component, element, or hardware designed or configured to perform various functions of the device 502, 504. The processing engine(s) 602 may include one or more processor(s) 124 and memory 126, where the memory 126 stores or maintains instructions executed by the processor(s) 124 to perform the corresponding function(s) of the processing engine 602. The processing engine(s) 602 may include a session establisher 604, a code generator 606, a model retriever 606, a model trainer 610, and a rendering engine 612, each described in greater detail below.

While these processing engine(s) 602 are shown and described, it is noted that, in various embodiments, additional or alternative processing engine(s) 602 may be deployed or supported by the respective device. Further, and in various embodiments, two or more of the processing engine(s) 602 may be combined into a single processing engine 602, and/or a processing engine 602 may be divided into multiple processing engine(s) 602. Additionally, while some processing engines 602 are shown as included on the first device 502 and other processing engines 602 are shown as included on the second device 504, it is noted that, in various embodiments, each of the devices 502, 504 may include instances of the processing engines 602 described herein. For example, the first device 502 may also include the model retriever 608, model trainer 610, and rendering engine 612, and the second device 504 may also include the code generator 606.

The system 500 may include the core network 600. The core network 600 may be or include any device(s), component(s), element(s), hardware(s), or network node(s) designed or configured to provide various functions which support a wireless (e.g., cellular) network. The core network 600 may provide a user plane function (UPF) 512, a session management function (SMF) 514, and/or an access and mobility management function (AMF) 516. The UPF 512 may be or include a function of the core network 600 which manages user data traffic, including routing, forwarding, and delivering such traffic to the intended destination. The SMF 514 may be or include a function of the core network 600 which manages (e.g., establishing, maintaining, and terminating) sessions between devices and the core network 600. The AMF 516 may be or include a function of the core network 600 which manages user connections and mobility, such as device registration, authentication, and tracking as the user moves across different network areas. While these functions are shown and described, it is noted that the core network 600 may provide additional functions other than those shown in FIG. 5 and FIG. 6.

The session establisher 604 may be configured to generate, negotiate, or otherwise establish a session (e.g., a communication session) between the first device 502 and the second device 504. In some embodiments, the session establisher 604 may be configured to transmit a signal from the first device 502 to the second device 504 to establish the session. The session establisher 604 may be configured to establish the session responsive to receiving a request to establish the session from a user of the first device 502. For example, a user may operate an application on the first device 502, and can select an option to initiate a video-based (or avatar-based) communication session with the second device 504. Continuing this example, the first device 502 may be configured to transmit the signal to the second device 504 responsive to the user selecting the option to initiate the session.

It is noted that, throughout the description herein, several functions are described with respect to the first device 502 or the second device 504. For example, for a communication session between the first device 502 and the second device 504, the first device 502 is described as providing information for the second device 504 to render an avatar which corresponds to the user of the first device 502. It should be understood that, in various embodiments, the devices 502, 504 may be interchangeable in that functions performed by the first device 502 may also be performed by the second device 504, and vice versa. For example, in some embodiments, for a communication session between the devices 502, 504, both devices could provide information to the other device 502, 504, such that the other device 502, 504 can render an avatar which corresponds to the user of the device 502, 504. Further, while two devices 502, 504 are described, any number of devices 502, 504 can be included in the communication session.

There are several options for performing an avatar-based communication session between the first device 502 and the second device 504. In some implementations, the first device 502 may be configured to generate and send audio and video data (e.g., RGB/RGB-D/etc.) to the second device 504, and the second device 504 can render the audio and video data synchronized. However, such implementations may result in increased bandwidth usage (e.g., by having to send the video data), increase in latency (e.g., resulting from the amount of information being shared), and so forth. To improve upon these drawbacks, according to the systems and methods described herein, the first device 502 (e.g., the session establisher 604 and code generator 606) may be configured to transmit information for obtaining a universal prior model (UPM) from a server 510 and an identity code corresponding to a user of the first device 502, to the second device 504. The second device 504 (e.g., the model retriever 608) may be configured to download the UPM from the server 510 based on the information from the first device 502. Once downloaded, the second device 502 (e.g., the model trainer 610) may train, adapt, modify, or otherwise configure the UPM using the identity code from the first device 502, to generate an avatar which corresponds to the user of the first device 502. As part of the communication session, the first device 502 may be configured to transmit, send, or otherwise provide animation/expression codes to the second device 504. The second device 504 (e.g., the rendering engine 612) may be configured to generate and render the avatar according to the expression codes received from the first device 502 (e.g., the code generator 606). In this regard, such implementations may decrease bandwidth usage and latency, by only having to share animation/expression codes, rather than video data itself.

Retrieving and downloading the UPM from the server 510 can result in a delay in establishing the session between the devices 502, 504. For example, the UPM downloaded from the server 510 can be, for example, ˜100 MB or more. This delay can ultimately delay session setup, particularly where the second device 504 attempting to download the UPM from the server 510 is also receiving other data/information/traffic from other internet/network sources.

In various embodiments, as part of (or following) establishing the communication session, the session establisher 604 (e.g., of the first device 502) may be configured to send, communicate, transmit, or otherwise provide information for obtaining the model (e.g., the UPM) from the server 510. In some embodiments, the session establisher 604 may be configured to provide the information in the signal (e.g., to request the session). In some embodiments, the session establisher may be configured to provide the information in a separate signal (e.g., separate from the request to establish the session). The information may include, for example, an address of the server 510 and a data size of the model to be downloaded from the server 510. The second device 504 may be configured to receive the address of the server 510 and the data size of the model from the first device 502.

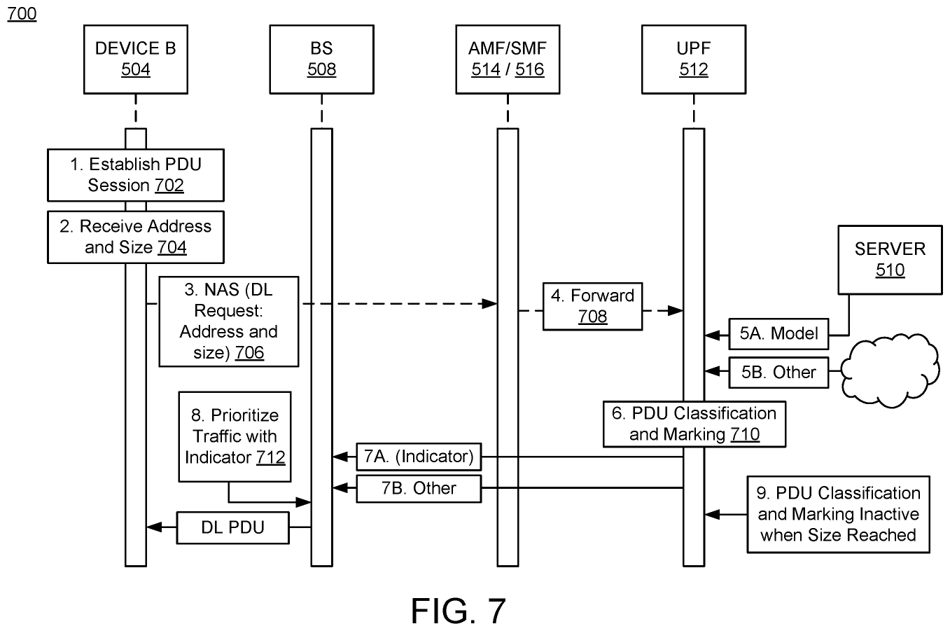

Referring to FIG. 7, with continued reference to FIG. 5 and FIG. 6, the second device, the model retriever 608 may be configured to download the model from the server 510 responsive to obtaining or otherwise receiving the address and data size from the first device. Specifically, FIG. 7 is a diagram showing a process flow 700 of supporting temporary data boost, according to an example implementation of the present disclosure. As shown in FIG. 7, at processes 702 and 704, the first device 502 and second device 504 may be configured to establish a protocol data unit (PDU) session (process 702) and the second device 504 may be configured to receive the address and data size from the first device 502 (process 704). While this process flow 700 is described with reference to the second device 504, it is noted that the first device 502 may be configured to execute a similar instance of the process flow 700 to retrieve the model for the second device 504, to configure an avatar corresponding to the user of the second device 504.

At process 706, the second device 504 (e.g., the model retriever 608 of the second device 504) may be configured to transmit, send, or otherwise provide a request to retrieve the model from the server 510. In some embodiments, the second device 504 may be configured to transmit the request to the core network 600 (e.g., through the base station or wireless communication node 508. The second device 504 may be configured to transmit the request via the non-access stratum (NAS) interface between the second device 504 and the core network 600. The request may include or otherwise identify the data size of the model and the address of the server 510. In some embodiments, the second device 504 may be configured to communicate the request via the base station 508 to the core network 600, for receipt by the AMF 514 and/or the SMF 516.

At process 708, the AMF 514 and/or SMF 516 may be configured to forward the request to the UPF 512. In some embodiments, the SMF 516 (or AMF 514) may be configured to forward the request to the UPF 512, to cause or otherwise instruct the UPF 512 to prioritize traffic/data corresponding to the model from the server 510 for transmission to the second device 504. For example, the request forwarded at process 708 may include instructions to mark or otherwise apply a downlink data burst indicator to data/traffic received from the server 510. The instructions may also indicate the data size, such that the downlink data burst indicator is applied to the data/traffic received from the server 510 up to an amount of data which equals the data size.

At steps 5A/5B, the UPF 514 may be configured to receive (e.g., over the N6 interface) various traffic for routing/sending/transmitting/providing to the second device 504. Such traffic may include data corresponding to the model (e.g., from the server 510) as well as various other data from other traffic sources. In some embodiments, the traffic received at both steps 5A/5B may have a common 5G quality of service (QOS) value (such as 5Q1-8), which may result in the same priority level of such traffic. However, as provided below, according to the request forwarded from the AMF 514 and/or SMF 516 at process 708, the UPF 512 may be configured to prioritize traffic from the server 510 (for a short term/duration according to the data size), to provide a higher priority of the traffic corresponding to the model from the server 510 relative to other traffic (despite having the same 5QI value).

At process 710, the UPF 512 may be configured to perform PDU classification and marking. The UPF 512 may be configured to classify PDUs received for the second device 504, based on or according to the address of the transmitting component/device (or source). For example, the UPF 512 may be configured to classify PDUs based on the address of the source. In this regard, the UPF 512 may be configured to classify PDUs as being from a source in which the UPF 512 is to prioritize traffic, and source(s) in which the UPF 512 is to deprioritize traffic. The UPF 512 may be configured to mark PDUs based on the corresponding classification. In some embodiments, the UPF 512 may be configured to mark the PDUs by applying information/indication(s) to a header of the PDUs. For example, the UPF 512 may be configured to apply the information/indication(s) to a general packet radio service (GPRS) tunneling protocol (GPT) user (GTP-U) header for the PDU(s), according to the classification. The UPF 512 may be configured to apply an indicator (e.g., a data burst indicator) to the GTP-U header(s) of PDUs which are classified as to be prioritized. In this regard, for the traffic/data/PDUs received at step 5A from the server 510, the UPF 512 may be configured to apply the indicator (e.g., downlink data burst indicator) to the data received from the server 510. Additionally, for the traffic/data/PDUs received at step 5B from other source(s), the UPF 512 may be configured to forego application of the indicator to the data received from such sources.

At steps 7A/7B, the UPF 512 may be configured to transmit, send, forward, or otherwise route the PDUs classified and marked at process 710 to the base station 508. In some embodiments, the UPF 512 may be configured to route the PDUs to the base station 508 via or over the N3 interface. The UPF 512 may be configured to route the PDUs to the base station 508, for delivery/transmission to the second device 504. As shown in FIG. 7, some of the traffic/PDUs may include the indicator (e.g., at step 7A), which may be or include the indicator included/incorporated into the header of the PDUs (e.g., the data burst indicator included in the GTP-U headers of the PDUs). Other traffic (e.g., at step 7B) may not include the header included/incorporated into the header of the PDUs.

The base station 508 may be configured to transmit, communicate, send, or otherwise provide the PDUs downlink to the second device 504. The base station 508 may be configured to provide the PDUs according to the indicators in the respective PDUs. In other words, the base station 508 may be configured to transmit the PDUs according to a priority of the PDUs set/defined by the core network 600 (e.g., the UPF 512). For example, the base station 508 may be configured to send PDUs having the indicator included in the header to the second device 504 ahead of other PDUs which do not include the indicator. In this regard, the second device 504 may be configured to receive the data corresponding to the model from the server 510, as prioritized by the core network 600 according to the request sent at process 706.

The second device 504 may be configured to receive the prioritized data according to the size of the model indicated in the request at process 706. As shown in step 9, the UPF 512 may be configured to prioritize data/PDUs from the server 510 up to the size of the model indicated in the request. For example, the UPF 512 may be configured to apply the indicator to the headers of PDUs, up until the UPF 512 applies indicators to PDUs having a sum payload equal to the data size indicated in the request. In this regard, the UPF 512 prioritizes data from the server 510 up until the full model (e.g., as indicated by the data size) is reached. Beyond that data size, the UPF 512 may apply the QCI level of the data to the PDUs from the server 510 in a manner similar to other traffic received by the UPF 512 for transmission to the second device 504. As such, a short term downlink data boost may be applied (e.g., by the UPF 512) for the model according to the data size indicated in the request.

Referring back to FIG. 5 and FIG. 6, once the data model has been downloaded or otherwise retrieved by the model retriever 608, the model trainer 610 may be configured to configure the model based on or according to information received from the first device 502. For example, the code generator 606 may be configured to communicate (e.g., as part of the signal sent to establish the session and/or once the session has been established) an identity code corresponding to the user of the first device 502. The identity code may be or include information for modifying/adapting/configuring the model from the server 510 as an avatar for the user of the first device. For example, the information may include adjustment weights, colors, background and foreground characteristics, etc., for configuring the avatar. The model trainer 610 may be configured to apply the information (e.g., the identity code) to the model received from the server 510, to configure/establish/generate an avatar associated with the user of the first device 502.

The first device 502 may be configured to transmit, send, or otherwise provide session data corresponding to the session between the first device 502 and the second device 504. Such session data may include, for example, audio data and/or other media data, and expression codes. The expression codes may be or include information relating to an expression of the user of the first device 502, for reflecting via the avatar rendered by the second device 504. For example, where a user is smiling, the first device 502 may be configured to transmit an expression code indicating that user is smiling. The expression data and/or audio data may be captured/obtained/sensed by one or more of the user input devices 422 (e.g., one or more cameras and microphones). The code generator 606 may be configured to generate the expression code based on the expression data, and can transmit the expression code and audio data via the session to the second device 504. In some embodiments, such information may be sent via separate data streams/data pipes (e.g., with the same or different 5QI values).

The rendering engine 612 may be configured to receive the expression codes and audio (and/or other) data from the first device 502. The rendering engine 612 may be configured to update, modify, or otherwise configure the avatar for the user of the first device 502, according to the expression code received from the first device 502. The rendering engine 612 may be configured to generate, render, or otherwise provide the avatar (e.g., via the user output device 424) with the audio data synchronized to the avatar. For example, as the user speaks while smiling, the rendering engine 612 may be configured to render the avatar (e.g., with the smiling expression) and have the avatar's lips synchronized with the audio data corresponding to the user's speech.

As noted above, while the process flow 700 is described with reference to the second device 504, a similar process flow 700 could be performed by the first device 502 (e.g., to render an avatar corresponding to a user of the second device 504, by downloading the model from the server 510 [or a different server 510], configuring the model according to an identity code for the user of the second device 504, and rendering the avatar based on expression codes and synchronized to audio from the user of the second device 504).

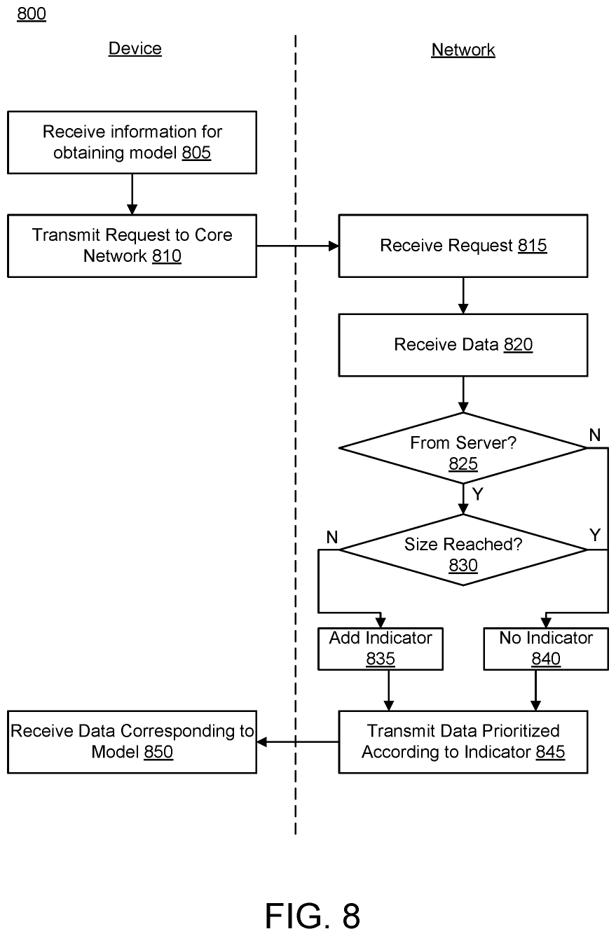

Referring now to FIG. 8, depicted is a flowchart showing an example method 800 for supporting temporary data boost, according to an example implementation of the present disclosure. The method 800 may be performed by the devices, elements, components, and/or hardware described above with reference to FIG. 1-FIG. 7. As a brief overview, at step 805, a device receives information for obtaining a model (e.g., from a server). At step 810, the device transmits a request to the network. At step 815, the network receives the request. At step 820, the network receives data. At step 825, the network determines if the data is from the server. At step 830, the network determines if a size limit has been reached. At step 835, the network adds an indicator to the data. At step 840, the network foregoes adding the indicator to the data. At step 845, the network transmits data prioritized according to the indicator. At step 850, the device receives the data corresponding to the model.

At step 805, a device receives information for obtaining a model (e.g., from a server). In some embodiments, the device is a first wireless communication device (described above as the second device 504) which receives the information from a second wireless communication device (described above as the first device 502). The device may receive the information in a signal from the second device. For example, the signal may include/incorporate/identify information for obtaining a model from a server. The model may be used by the device to generate an avatar associated with a user of the second device. The information may include, for example, the address of the server (from which the model is to be obtained) and the data size of the model. In some embodiments, the device may receive the information at step 805, responsive to and/or as part of establishing a communication session with the second device. For example, a user of the device may launch an application and request to establish the communication session with the second device (or vice versa). Once the request has been accepted by the user of the second device (or as part of such signaling to establish the communication session), the second device may send the information for obtaining the model to the first device.

In some embodiments, the device may receive an identity code corresponding to the user of the second device. In some embodiments, the device may receive the identity code with the information included in the signal (e.g., from the second device). In some embodiments, the device may receive the identity code responsive to establishing the communication session. In some embodiments, the device may receive the identity code responsive to downloading the model from the server. For example, upon downloading the model from the server, the device may request the identity code from the second device and the second device may send, responsive to the request, the identity code to the device. The device may use the identity code to configure the model to generate an avatar for the user, as described below.

At step 810, the device transmits a request to the network. In some embodiments, the device may transmit the request to the core network (e.g., via a base station or wireless communication node). The device may transmit the request to the core network according to the information received at step 805. The device may generate the request to include the information to obtain the model from the server via the core network. The request may include, incorporate, or otherwise identify a data size of the model and an address of the server. The device may transmit the request via the base station or wireless communication node. The base station/wireless communication node may forward, communicate, send, or otherwise provide the request to the core network.

At step 815, the network receives the request. In some embodiments, the core network receives the request (e.g., via the base station) from the device. The core network may receive the request via the non-access stratum (NAS). In some embodiments, a session management function (SMF) of the core network may receive the request. Upon the SMF receiving the request from the device, the SMF may instruct a user plane function (UPF) of the core network to prioritize the data corresponding to the model from the server. The SMF may instruct the UPF to prioritize the data corresponding to the model by providing/applying an indicator (e.g., a downlink data burst indicator) to data received from the server. In some embodiments, the SMF may provide to the UPF the server address and the data size (e.g., from the request received at step 815).

At step 820, the network receives data. In some embodiments, the core network may receive the data from one or more sources. For example, the core network may receive data from the server (e.g., data corresponding to the model) and data from one or more other sources (e.g., other server(s) or endpoints). At step 825, the network determines if the data is from the server. In some embodiments, the core network may determine if the data is from the server by determining if the address of the data received at step 820 matches the address of the server. Where the core network determines that the address does not match the server address, the method 800 may proceed to step 840. Where the core network determines that the data is from the server (e.g., based on the address of the source of the data matching the server address), the method 800 may proceed to step 830.

At step 830, the network determines if a size limit has been reached. In some embodiments, the network may determine if the size limit has been reached, based on the data size of the model. For example, as the network receives data from the server, the network (e.g., UPF) may compare the amount of data (e.g., received from the server) to the data size of the model indicated in the request received at step 815. Where the size limit has not been reached, the method 800 may proceed to step 835.

At step 835, the network adds an indicator to the data. In some embodiments, the network (e.g., the UPF) may add an indicator to data from the server, provided that the size limit has not been reached. The indicator may be or include a downlink data burst indicator. The network may add the indicator to a header of the data. The network may add the indicator, to indicate that the base station is to prioritize the data (e.g., inclusive of the indicator) relative to other data. In this regard, the network may add the indicator to the data up to the data size of the model (e.g., providing a temporary data boost for downloading the model). At step 840, the network foregoes adding the indicator to the data. The network may forego adding the indicator to data from other sources (e.g., other than the server corresponding to the address identified in the request), and from the server for data other than the data corresponding to the model. In this regard, once the size limit has been reached (e.g., the amount of data to which the UPF has added the indicator is equal to the data size of the model), the UPF may forego adding the indicator to data from the server.

At step 845, the network transmits data prioritized according to the indicator. In some embodiments, the network may transmit the data with the indicator(s) added at step 835, and other data without the indicator, to a base station/wireless communication node, for delivery to the device. The base station may deliver/transmit/send/provide the data to the device, where the data is prioritized according to the indicator. At step 850, the device receives the data corresponding to the model. In some embodiments, the device may receive the data via the core network from the server, where the data corresponds to the model from the server. The data may thus be prioritized by the core network according to the request. For example, where the wireless communication node receives data including the indicator for transmission to the device, and data which does not include the indicator, the wireless communication node may transmit (e.g., first) the data including the indicator, to prioritize delivery of the model from the server to the device.

In some embodiments, following the device receiving the model (e.g., each of the data packets/PDUs which include the model), the device may configure the model received from the server using an identity code received from the second device, to generate the avatar associated with the user of the second wireless communication device. For example, the device may apply the identity code as an input to the model, to generate/configure the model specific to the user of the second device. The device may receive the identity code with the information obtained from the second device (e.g., at step 805). Additionally or alternatively, the device may receive the identity code as part of session negotiation, and/or after the model has been downloaded (e.g., by sending a request for the identity code and receiving a response from the second device inclusive of/indicating the identity code).

Once the device receives the identity code and configures the model, the device may generate and render an avatar for the user of the second device. For example, the device may receive (e.g., as part of the wireless communication session with the second device) an expression code and an audio stream from the second device. The second device may generate the expression code based on sensed expressions of the user, and can generate the audio stream based on recorded/measured audio from the user. The second device may transmit the expression code and audio stream via one or more channels/data pipe(s) with respective QoS metrics/configurations. The first device may receive the expression code and audio stream from the second device. The first device may render the avatar of the user according to the expression code. For example, the first device may apply the expression code to the configured model, to generate the avatar having an expression which corresponds to the expression code. The first device may render the audio stream with the avatar. For example, the first device may render the audio stream synchronized with the rendering of the avatar (e.g., by synchronizing lip movements of the avatar with the audio stream).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a first wireless communication device, a signal from a second wireless communication device, the signal including information for obtaining a model from a server used by the first wireless communication device to generate an avatar associated with a user of the second wireless communication device;
transmitting, by the first wireless communication device to a core network, a request to retrieve the model from the server, the request identifying a data size of the model and an address of the server; and
receiving, by the first wireless communication device via the core network from the server, data corresponding to the model from the server, the data prioritized by the core network according to the request.

2. The method of claim 1, wherein the information includes the address of the server and the data size of the model.

3. The method of claim 1, wherein the first wireless communication device receives the signal from the second wireless communication device, to establish a communication session between the first wireless communication device and the second wireless communication device.

4. The method of claim 1, further comprising receiving, by the first wireless communication device, an identity code corresponding to the user of the second wireless communication device.

5. The method of claim 4, wherein the identity code is received in the signal from the second wireless communication device.

6. The method of claim 1, wherein a session management function (SMF) of the core network instructs a user plane function (UPF) of the core network to prioritize the data corresponding to the model from the server, by applying a downlink data burst indicator to data received from the server.

7. The method of claim 6, wherein the downlink data burst indicator is applied to an amount of data received from the server equal to the data size of the model.

8. The method of claim 1, further comprising:
configuring, by the first wireless communication device, the model received from the server using an identity code received from the second wireless communication device, to generate the avatar associated with the user of the second wireless communication device.

9. The method of claim 8, further comprising:
receiving, by the first wireless communication device, an expression code and an audio stream from the second wireless communication device;
rendering, by the first wireless communication device, the avatar of the user according to the expression code; and
rendering, by the first wireless communication device, the audio stream synchronized with the rendering of the avatar.

10. A first wireless communication device, comprising:
a wireless transceiver; and
one or more processors configured to:
receive, via the wireless transceiver, a signal from a second wireless communication device, the signal including information for obtaining a model from a server used by the first wireless communication device to generate an avatar associated with a user of the second wireless communication device;
transmit, via the wireless transceiver to a core network, a request to retrieve the model from the server, the request identifying a data size of the model and an address of the server; and
receive, via the wireless transceiver, through the core network from the server, data corresponding to the model from the server, the data prioritized by the core network according to the request.

11. The first wireless communication device of claim 10, wherein the information includes the address of the server and the data size of the model.

12. The first wireless communication device of claim 10, wherein the one or more processors receive the signal from the second wireless communication device, to establish a communication session between the first wireless communication device and the second wireless communication device.

13. The first wireless communication device of claim 10, wherein the one or more processors are configured to receive, via the wireless transceiver, an identity code corresponding to the user of the second wireless communication device.

14. The first wireless communication device of claim 13, wherein the identity code is received in the signal from the second wireless communication device.

15. The first wireless communication device of claim 10, wherein a session management function (SMF) of the core network instructs a user plane function (UPF) of the core network to prioritize the data corresponding to the model from the server, by applying a downlink data burst indicator to data received from the server.

16. The first wireless communication device of claim 15, wherein the downlink data burst indicator is applied to an amount of data received from the server equal to the data size of the model.

17. The first wireless communication device of claim 10, wherein the one or more processors are configured to:
configure the model received from the server using an identity code received from the second wireless communication device, to generate the avatar associated with the user of the second wireless communication device.

18. The first wireless communication device of claim 17, wherein the one or more processors are configured to:
receive, via the wireless transceiver, an expression code and an audio stream from the second wireless communication device;
render the avatar of the user according to the expression code; and
render the audio stream synchronized with the rendering of the avatar.

19. A network node, comprising:
one or more processors configured to:
implement a session management function (SMF) configured to:
receive, from a wireless communication device, a request to retrieve data from a server, the request identifying a data size of the data to be retrieved from the server; and
transmit, to a user plane function (UPF), instructions to prioritize the data received from the server for transmission to the wireless communication device up to the data size; and
implement the UPF configured to:
apply, according to the instructions, a downlink burst indicator to the data received from the server, up to the data size; and
transmit the data received from the server, with the downlink burst indicator, to a wireless communication node for transmission to the wireless communication device.

20. The network node of claim 19, wherein the wireless communication node prioritizes transmission of the data including the downlink burst indicator to the wireless communication device, over other data for transmission to the wireless communication device.
